(19) United States
(12) Patent Application Publication
(10) Pub. No.: US 2016/0299712 A1
(43) Pub. Date: Oct. 13, 2016

(54) Virtual Machines Backed by Host Virtual Memory

(71) Applicant: Microsoft Technology Licensing, LLC, Redmond, WA (US)

(72) Inventors: Arun U. Kishan, Kirkland, WA (US); Landy Wang, Honolulu, HI (US); Mehmet Iyigun, Kirkland, WA (US); Kevin Michael Broas, Kirkland, WA (US); Yevgeniy M. Bak, Redmond, WA (US)

(21) Appl. No.: 14/697,398

(22) Filed: Apr. 27, 2015

Related U.S. Application Data
(60) Provisional application No. 62/144,208, filed on Apr. 7, 2015.

(51) Int. Cl. G06F 3/06; G06F 12/10; G06F 9/455; G06F 12/08

(52) U.S. Cl. CPC G06F 3/0619; G06F 3/0604; G06F 3/0631; G06F 3/065; G06F 3/0664; G06F 3/0671; G06F 12/0891; G06F 12/1027; G06F 9/45558; G06F 2212/60; G06F 2212/50; G06F 2009/45583

(57) ABSTRACT

A host machine having guest virtual machine physical memory backed by host virtual memory is described. The host machine includes host physical memory. The host machine further includes one or more guest virtual machines. Each of the guest virtual machines includes guest physical memory. The host machine further includes host virtual memory. The host machine further includes a data structure having a correlation of guest physical memory addresses to host virtual memory addresses and a data structure having a correlation of host virtual memory addresses to host physical memory addresses.

### CROSS-REFERENCE TO RELATED APPLICATIONS

This application claims the benefit of and priority to U.S. Provisional Patent Application Ser. No. 62/144,208 filed on Apr. 7, 2015 and entitled “Virtual Machines Backed by Host Virtual Memory,” which application is expressly incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc. Modernly, computing systems may implement the concept of virtual computing. In virtual computing a host physical machine (hereinafter “host”) may host a number of guest virtual machines (hereinafter “guests” or “virtual machines”). The virtual machines share physical resources on the host. For example, the virtual machines use physical processors and physical memory at the host to implement the virtual machines.

Currently virtual machines' physical memory is backed by non-paged physical memory allocations in the host in a one to one fashion. The virtualization stack that manages virtual machines allocates this type of memory from the host and the host has no control over that memory after allocation. The virtualization stack fully manages that memory after it is allocated. It chooses how to distribute the memory between virtual machines, whether to make it pageable from the guest's point of view, etc. With virtual machines as currently implemented, the memory management logic that exists in the host (e.g., demand paging, page de-duplication, prioritization, prefetching, compression, etc.) cannot be leveraged to manage the guest virtual machines' physical memory. Thus, many features and optimizations are duplicated in the virtualization stack to manage the guest physical memory (e.g., providing second level paging).

Further, increasing virtual machine density on a host has become an important part of virtualization solutions to be able to take better advantage of server hardware by packing more virtual machines (while having those virtual machines perform well enough to run their desired workloads). Currently virtual machine density is mostly limited by host memory size. Thus, for example, if a host machine has 12 GB of RAM that can be allocated to virtual machines, that host can only host a number of virtual machines where the total memory for all of the virtual machines together is 12 GB or less.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a host machine. The host machine includes host physical memory. The host machine further includes one or more guest virtual machines. Each of the guest virtual machines includes guest physical memory. The host machine further includes host virtual memory. The host machine further includes a data structure having a correlation of guest physical memory addresses to host virtual memory addresses and a data structure having a correlation of host virtual memory addresses to host physical memory addresses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a host machine having guest physical memory backed by host virtual memory;

FIG. 2 illustrates examples of host virtual memory backing guest physical memory;

FIG. 3 illustrates a flow chart showing the various actions in the lifecycle of data in guest physical memory that is backed by host virtual memory; and

FIG. 4 illustrates a method of backing guest physical memory with host virtual memory.

### DETAILED DESCRIPTION

Some embodiments described herein use virtual memory allocated from a user-mode process on the host (or other virtual memory allocation) to back a virtual machine's guest physical memory rather than using non-paged physical memory allocations on the host. This allows the host kernel's memory management to manage the host physical memory associated with the guest physical memory. In particular, memory management logic that already exists in the host can now be leveraged to manage the guest virtual machines' physical memory. This can allow for the use of a smaller hypervisor, in terms of the amount of code used to implement the hypervisor. A smaller hypervisor, which is the trusted portion between the host and the virtual machines, can be more secure than larger hypervisors as there is less code that can be exploited or that may have errors. Further, this allows for increased density on the host. Embodiments can use existing logic in a host memory manager to increase virtual machine density on the host by using less host physical memory to implement virtual machines than previously required.

This can exhibit one or more benefits. For example, one memory management code base manages all of the memory on the system (host and virtual machine). Thus, improvements, fixes and/or tuning in one code base benefits everyone. Further, this can result in a reduction in engineering cost due to only having to maintain one code base. Another example benefit may be that virtual machines can immediately benefit from density improvements such as paging, page sharing, working set aging and trimming, fault clustering, etc. Another example benefit may be that virtual memory and physical memory consumption limits can be set on virtual machines just like any other process, allowing administrators ability to control the system behavior. Another example benefit may be that additional features can be added to the host memory manager to provide more performance, density and functionality for virtual machines (and other non-virtual machine workloads will likely benefit from these as well).

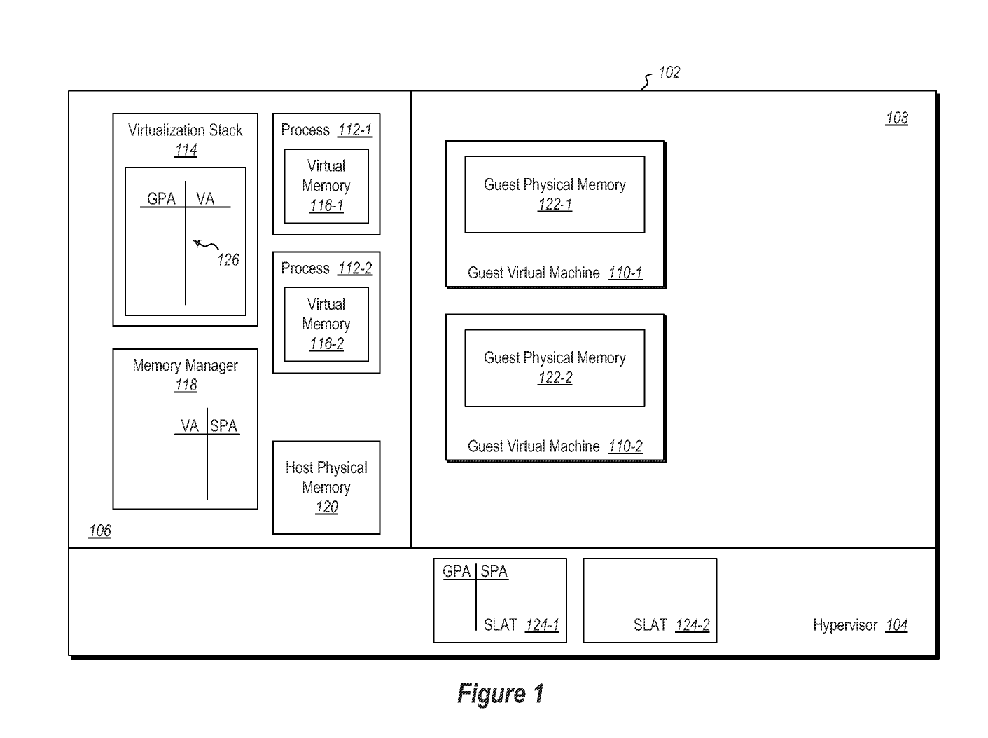

Referring now to FIG. 1, a host 102 is shown. The host 102 may be a physical host server machine capable of hosing a number of guest virtual machine. The host 102 includes a hypervisor 104. A hypervisor is a piece of computer software, firmware and/or hardware that manages virtual machines on a host.

The host 102 includes a host portion 106 and a guest portion 108. The host portion 106 hosts user-mode processes for the host 102 itself. The guest portion 108 host guest virtual machines. In the example illustrated, the guest portion 108 hosts guest 110-1 and guest 110-2. While only two guest virtual machines are illustrated, it should be appreciated the host 102 is capable of hosting more virtual machines than this.

Embodiments may be implemented where a user-mode process is implemented in the host portion 106 to provide virtual memory 116 for backing guest virtual machines in the guest portion 108. In the particular example illustrated, a user-mode process is created for each guest machine. Thus, FIG. 1 illustrates user-mode processes 112-1 and 112-2 corresponding to virtual machines 110-1 and 110-2 respectively. However, it should be appreciated that a single user-mode process could be used for multiple virtual machines, or multiple processes may be used for a single virtual machine. Alternatively, virtual memory 116 could be implemented in other fashions than using a user-mode process as will be illustrated below.

The virtualization stack 114 allocates regular virtual memory (e.g., virtual memory 116-1 and 116-2 in processes 112-1 and 112-2 respectively) in the address space of a designated user-mode process that will host the virtual machine. The host memory manager 118 can treat this memory as any other virtual allocation, which means that it can be paged, the physical page backing it can be changed for the purposes of satisfying contiguous memory allocations elsewhere on the system, the physical pages can be shared with another virtual allocation in another process (which in-turn can be another virtual machine backing allocation or any other allocation on the system). At the same time, many optimizations are possible to make the host memory manager 118 treat the virtual machine backing virtual allocations specially as necessary. Also, if the virtualization stack 114 chooses to prioritize performance over density, it can perform many operations supported by the operating system host memory manager 118 such as locking the pages in host physical memory 120 to ensure that the virtual machine will not experience paging for those portions. Similarly, large pages can be used to provide even more performance for the virtual machine as necessary.

A given virtual machine (e.g., virtual machine 110-1) can have all of its guest physical memory addresses in guest physical memory (e.g., guest physical memory 122-1) backed by virtual memory (e.g., virtual memory 116-1) or can have some of its guest physical memory addresses in guest physical memory (e.g., guest physical memory 122) backed by virtual memory (e.g., virtual memory 116) and some by legacy mechanisms such as non-paged physical memory allocations made from the host physical memory 120.

When a new virtual machine (e.g., virtual machine 110-1) is created, the virtualization stack 114 uses a user-mode process (e.g., user-mode process 112-1) to host the virtual memory 116 allocation to back the physical memory (e.g., guest physical memory 122-1) of the virtual machine 110-1. This can be a newly created empty process, an existing process hosting multiple virtual machines, or a process per virtual machine that also contains other virtual machine-related virtual allocations that are not visible to the virtual machine itself (e.g., virtualization stack 114 data structures 126). It's also possible to use kernel virtual address space to back the virtual machine. Once such a process is found or created, the virtualization stack 114 makes a private memory virtual allocation (or a section/file mapping) in its address space that corresponds to the amount of guest physical memory 122-1 the virtual machine 110-1 should have. Specifically, the virtual memory 116 can be a private allocation, a file mapping, a pagefile-backed section mapping or any other type of allocation supported by the host memory manager 118. This does not have to be one contiguous allocation. It can be an arbitrary number of allocations and each allocation effectively describes a physical range of memory in the host physical memory 120 of the corresponding size in the virtual machine 110-1.

Once the virtual memory 116 allocations have been made, they are registered with the components that will manage the physical address space of the virtual machine 110-1 and keep it in sync with the host physical memory pages that the host memory manager 118 will choose to back the virtual memory 116 allocations. These components are the hypervisor 104 and the virtualization stack 114 that is part of the host kernel and/or a driver. The hypervisor 104 manages the guest physical memory address ranges by utilizing SLAT (Second Level Address Translation) features in the hardware. In particular, FIG. 1 illustrates a SLAT 124-1 and a SLAT 124-2 corresponding to the virtual machines 110-1 and 110-2 respectively. The virtualization stack 114 updates the SLAT 124-1 with the host physical memory pages that are backing the corresponding guest physical memory pages. The hypervisor 104 exposes the ability for the virtualization stack 114 to receive intercepts when a certain access type is performed by the guest virtual machine 110-1 to a given guest physical memory address. For example, the virtualization stack 114 can request to receive an intercept when a certain physical address is written by the guest virtual machine 110-1.

When a guest virtual machine 110-1 is first created, its SLAT 124-1 does not contain any valid entries because no host physical memory addresses have been allocated to back the guest physical memory addresses (although as illustrated below, in some embodiments, the SLAT 124-1 can be prepopulated for some guest physical memory addresses at or around the same time as the creation of the guest virtual machine 110-1). The hypervisor 104 is aware of the guest physical memory address ranges the guest virtual machine 110-1 is composed of, but none of them are backed by any host physical memory at this point. When the guest virtual machine 110-1 begins execution, it will begin to access its (guest) physical memory pages. As each new physical memory address is accessed, it will generate an intercept of the appropriate type (read/write/execute) since the corresponding SLAT entry is not populated with host physical memory addresses (represented as SPAs) yet. The hypervisor 104 receives the guest access intercept and forwards it to the virtualization stack 114 running in the host. The virtualization stack 114 refers to its data structure 126 indexed by guest physical memory address range to find the virtual address range that is backing it (and the host process 112-1 whose virtual address space the backing was allocated from). At that point, the virtualization stack 114 knows the specific host virtual memory 116 address that corresponds to the guest physical memory address that generated the intercept.

The virtualization stack 114 then issues a virtual fault to the host memory manager 118 in the context of the host process 112-1 hosting the virtual address range. It does this by attaching to the process address space if necessary. The virtual fault is issued with the corresponding access type (read/write/execute) of the original intercept that occurred when the guest virtual machine 110-1 accessed its physical address in guest physical memory 122-1. A virtual fault executes basically the same code path as a regular page fault would take to make the specified virtual address valid and accessible by the host CPU. The one difference is that this code path returns the physical page number that the host memory manager 118 used to make the virtual address valid. This physical page number is the host physical memory address (SPA) that is backing the virtual address and is in-turn backing the guest physical memory address that originally generated the access intercept in the hypervisor 104. At this point, the virtualization stack 114 updates the SLAT entry in the SLAT 124-1 corresponding to the original guest physical memory address that generated the intercept with the host physical memory address and the access type (read/write/execute) that was used to make the virtual address valid in the host. Once this is done, the guest physical memory address is immediately accessible with that access type to the guest virtual machine 110-1 (e.g., a parallel virtual processor in the guest virtual machine 110-1 can immediately access it without hitting an intercept). The original intercept handling is complete and the original virtual processor that generated the intercept can retry its instruction and proceed to access the memory now that the SLAT entry has been filled.

If and/or when the host memory manager 118 decides to perform any action that could or would change the physical address backing of the virtual address that was made valid via a virtual fault, it will perform a translation buffer (TLB) flush for that virtual address. It already does this to conform with the existing contract the host memory manager 118 has with hardware CPUs on the host 102. The virtualization stack 114 will now intercept such TLB flushes and invalidate the corresponding SLAT entries of any virtual addresses that are flushed that are backing any guest physical memory addresses in any virtual machines. The TLB flush call comes with a range of virtual addresses being flushed. The virtualization stack 114 looks up the virtual addresses being flushed against its data structures 126 indexed by virtual address to find guest physical ranges that may be backed by the given virtual address. If any such ranges are found, the SLAT entries corresponding to those guest physical memory addresses are invalidated. Additionally, the host memory manager 118 can treat virtual allocations that back VMs differently if necessary or desired to optimize TLB flush behavior (e.g., to reduce SLAT invalidation time, subsequent memory intercepts, etc.)

The virtualization stack 114 has to carefully synchronize updating the SLAT 124-1 with the host physical memory page number returned from the virtual fault (serviced by the host memory manager 118) against TLB flushes performed by the host 102 (issued by the host memory manager 118). This is done to avoid adding complex synchronization between the host memory manager 118 and the virtualization stack 114. The physical page number returned by the virtual fault may be stale by the time it is returned to the virtualization stack 114. For example, the virtual addresses may have already been invalidated. By intercepting the TLB flush calls from the host memory manager 118, the virtualization stack 114 can know when this race occurred and retry the virtual fault to acquire the updated physical page number.

When the virtualization stack 114 invalidates a SLAT entry, any subsequent access to that guest physical memory address by the virtual machine 110-1 will again generate an intercept to the hypervisor 104, which will in-turn be forwarded to the virtualization stack 114 to be resolved as described above. The same process can repeat when a guest physical memory address is accessed for read first and then is written to later. The write will generate a separate intercept because the SLAT entry was only made valid with “Read” access type. That intercept will be forwarded to the virtualization stack 114 as usual and a virtual fault with “Write” access will be issued to the host memory manager 118 for the appropriate virtual address. The host memory manager 118 will update its internal state (typically in the page table entry (PTE)) to indicate that the host physical memory page is now dirty. This is done before allowing the virtual machine to write to its guest physical memory address to avoid data loss and/or corruption. If and/or when the host memory manager 118 decides to trim that virtual address (which will perform a TLB flush and invalidate the corresponding SLAT entry as a result), the host memory manager 118 will know that the page is dirty and needs to be written to virtual memory 116 on disk, such as a pagefile before being repurposed. This is like what would happen for a regular private virtual allocation in any process running on the host 102.

The host memory manager 118 can choose to perform a page combing pass over all of its memory 120. This is an operation where the host memory manager 118 finds identical pages across all processes and combines them into one read-only copy of the page that all processes share. If and/or when any of the combined virtual addresses are written to, the host memory manager 118 will perform a copy-on-write operation to allow the write to proceed. This will now work transparently across virtual machines (e.g., virtual machines 110-1 and 110-2, as well as any other virtual machines on the host 102) to combine any and all identical pages across virtual machines. When page combining occurs, the host memory manager 118 will update PTEs that map the virtual addresses being affected. During this update, it will perform a TLB flush because the host physical memory address is changing for those virtual addresses (from the unique private page to the shared page that all processes will point to). As part of this, as described above, the virtualization stack 114 will invalidate the corresponding SLAT entries. If and/or when the guest physical memory addresses, whose virtual addresses were combined to point to the shared page, are read the virtual fault resolution will return the physical page number of the shared page during intercept handling and the SLAT 124-1 will be updated to point to the shared page. If any of the combined guest physical memory addresses are written to by the guest virtual machine 110-1, the virtual fault with write access will perform a copy-on-write operation and a new private host physical memory page number will be returned and updated in the SLAT 124-1.

For example, the virtualization stack 114 can direct the host memory manager 118 to perform a page combining pass. In some embodiments, it is possible for the virtualization stack 114 to specify which portion of memory is to be scanned for combing or which processes that back VMs should be scanned, etc. Page combining is one way that VM density can be increased (by sharing physical pages between VMs that are identical).

Even when the SLAT 124-1 is updated to allow write access due to a virtual fault being performed for write, the hypervisor 104 can support triggering intercepts on writes to such SLAT entries if requested by the virtualization stack 114. This is useful because the virtualization stack 114 may want to know when writes occur regardless of the fact that it is acceptable to the host memory manager 118 for these writes to occur. An example of this is live migration of virtual machines or virtual machine snapshotting. The virtualization stack 114 prefers to be notified when writes occur even though the host memory manager's 118 state has already been updated accordingly for writes. For example, the PTE may have been marked dirty.

The host memory manager 118 is able to maintain accurate access history for each virtual page backing the guest physical memory address space just like it does for regular virtual pages allocated in any process address space. For example, an “accessed bit” in the PTE is updated during virtual faults performed as part of handling memory intercepts. When the host memory manager 118 clears the accessed bit on any PTE, it already flushes the TLB on regular CPUs to avoid memory corruption. As described before, this TLB flush will invalidate the corresponding SLAT entry, which in turn will generate an access intercept if the virtual machine 110-1 accesses its guest physical memory address again. As part of handling the intercept, the virtual fault processing in the host memory manager 118 will set the accessed bit again thus maintaining proper access history for the page. Alternatively, for performance reasons to avoid access intercepts in the hypervisor 104 as much as possible, the host memory manager 118 can consume page access information directly from the hypervisor 104 as gathered from the SLAT entries (if supported by the underlying hardware). The host memory manager 118 would cooperate with the virtualization stack 114 to translate access information in the SLAT 124-1 (which is organized by guest physical memory addresses) to the host virtual memory 116 addresses backing those guest physical memory addresses to know which addresses were accessed.

By having accurate access history for the pages, the host memory manager 118 can run its usual intelligent aging and trimming algorithms of process' working sets. This allows the host physical memory 120 backing virtual machines to seamlessly participate. The host memory manager 118 can examine the state of the whole system and make intelligent choices about which addresses to trim and/or page out to disk, etc., to alleviate memory pressure if necessary or for other reasons.

In some embodiments, virtual and physical memory limits can be imposed on virtual machines by the host memory manager 118 just like any other process on the system. This helps the system administrator sandbox, or otherwise constrain or enable, the guest virtual machines 110-1 and 110-2. The host system would use the same mechanisms to accomplish this as it would for native processes. For example, in some embodiments where higher performance is desired, a virtual machine can have the entirety of its guest physical memory 122 backed directly by host physical memory 120. Alternatively, portions may be backed by virtual memory 116 and portions backed by host physical memory 120. In yet another example where lower performance is acceptable, a virtual machine can be backed by virtual memory 116, where the virtual memory 116 is limited to less than full backing by physical memory. For example, a guest physical memory 122-1 may be 4 GB in size and may be backed by virtual memory 116-1, which is also at least 4 GB in size. However, the virtual memory 116-1 may be constrained to be backed by only 2 GB of memory in the host physical memory 120. This may cause paging to disk or other performance hindrances, but may be a way for administrators to throttle based on service levels or exert other control on virtual machine deployment. Similarly, a certain amount of physical memory may be guaranteed to the VM (while still being virtually backed) as supported by the host memory manager 118 to provide a certain consistent level of performance.

Guest physical memory addresses can be dynamically added and/or removed from the guest virtual machine 110-1. When the physical memory needs to be added to the guest virtual machine 110-1, another virtual address range is allocated as described earlier. Once the virtualization stack 114 is ready to handle access intercepts on the memory, the physical range can be added to the guest virtual machine 110-1. When removing guest physical memory addresses, a number of things can be done. The portions of the virtual address range in the virtual memory 116-1 backing the removed guest physical memory addresses in the guest physical memory 122-1 can be freed with the host memory manager 118 (and updated accordingly in the virtualization stack 114 data structures 126). Alternatively, various host memory manager 118 APIs can be called on those portions of the virtual address range to free the host physical memory pages without releasing the virtual address space for it. Alternatively, in some embodiments, it is possible to do nothing at all since the host memory manager 118 will eventually trim these pages from the working set and eventually write them to the disk, such as a pagefile, because they will not be accessed any more in practice.

Various additional enlightenments can be added between the host memory manager 118 and the memory manager running in the guest virtual machine 110-1 to optimize the density and performance. For example, in addition to page sharing to increase density by page combining, file data can be shared between the host 102 and guest virtual machines by mapping the file in the host process virtual address space in virtual memory 116-1 and communicating that information to the virtual machine via the virtualization stack 114. This would increase density more directly than page sharing (since sharing candidate pages are first found by page combining, which consumes CPU resources) and also improves virtual machine performance by having the file data be readily available in the physical memory of the guest virtual machine, instead of having to read it from the host and then use page sharing to increase density. In yet another example, new virtual machines can be created very efficiently using a “template virtual machine” by cloning the virtual address space of the existing virtual machine, which will automatically point both virtual machines to the same physical memory to share for read purposes. As soon as Pone of the virtual machines writes to its guest physical memory, forking will result in that page becoming private to that virtual machine.

In some embodiments, the SLAT 124-1 could be prepopulated with some or all guest physical memory address to host physical memory address mappings. This would reduce the number of fault handling operations performed at virtual machine initialization. However, as the virtual machine operates, entries in the SLAT 124-1 will be invalidated for various reasons, and the fault handling described above can be used to one again correlate guest physical memory addresses to host physical memory addresses where the guest physical memory 122-1 is backed by virtual memory 116-1. The SLAT entries can be prepopulated before VM boot or at runtime as deemed desired by the virtualization stack 114 and the host 102. The entire SLAT 124-1 or any portion of it may be pre-populated as desired.

Alternatively or additionally, one optimization may be implemented where the physical memory backing the host virtual allocation can be pre-fetched into memory such that when a subsequent memory intercept arrives due the guest virtual machine 110-1 accessing its guest physical memory 122-1, the virtual fault can be satisfied faster (without having to go to disk to read the data).

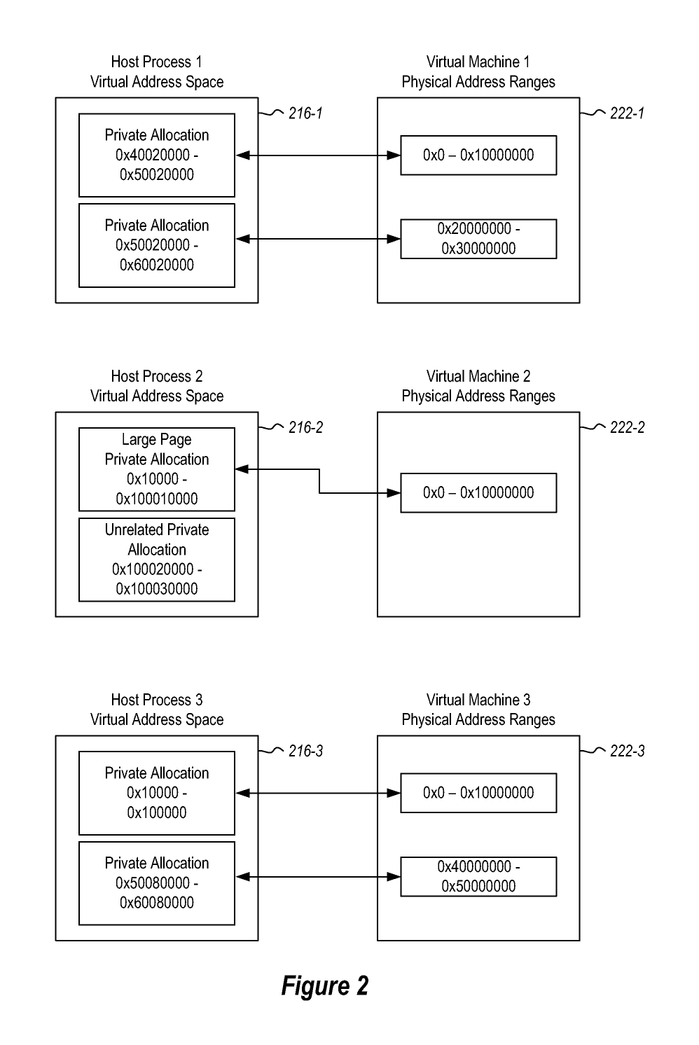

Referring to FIG. 2, several examples of virtual memory 216 backing guest physical memory are illustrated. In particular, FIG. 2 illustrates virtual memory 216-1, 216-2 and 216-3 backing guest physical memory 222-1, 222-2, and 222-3 respectively. FIG. 2 illustrates a number of different types of memory allocations backing guest physical memory and a different number of allocations mapping the same amount of guest physical memory amounts, etc. While these examples are shown, it should be appreciated that various other possible allocations may be alternatively or additionally implemented.

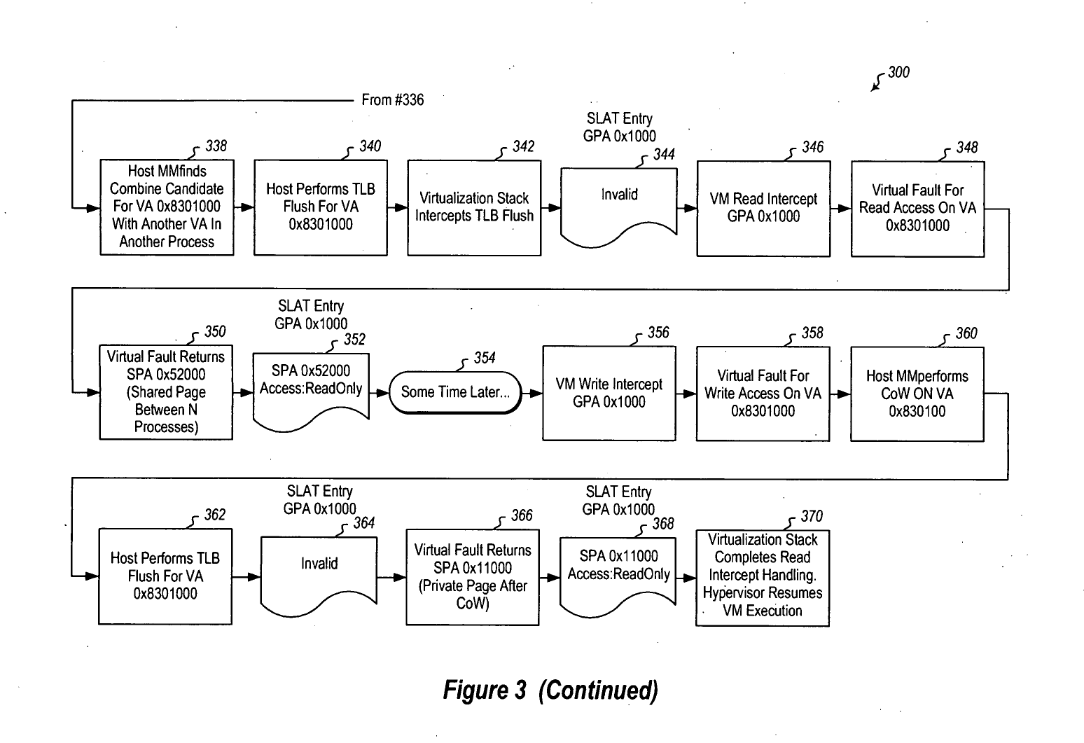

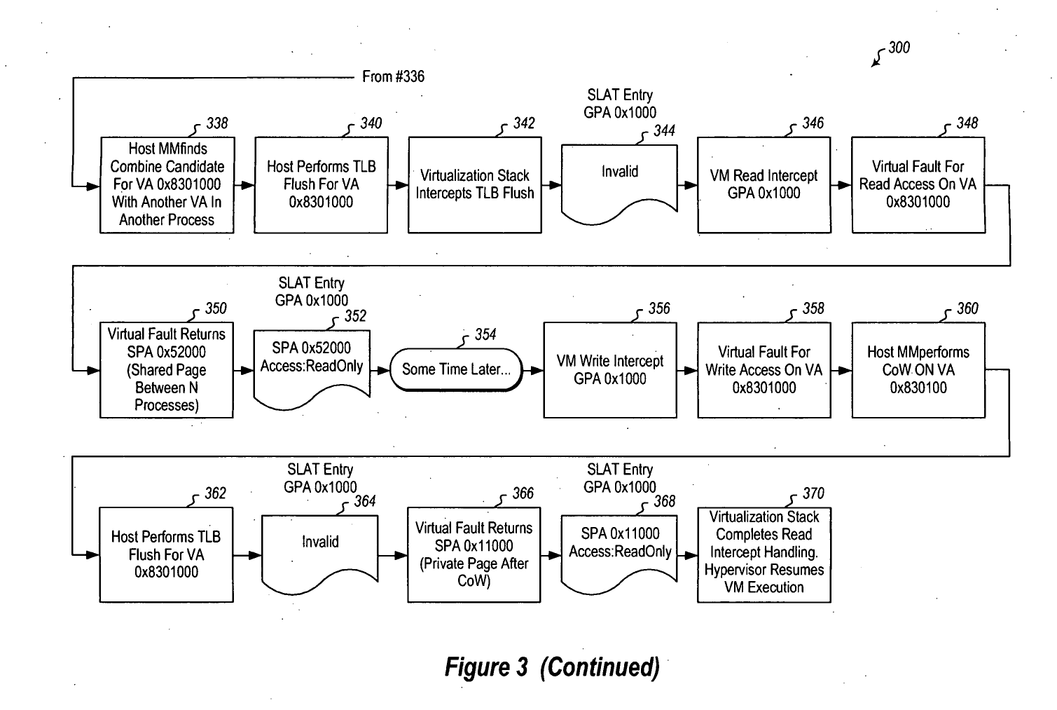

Referring now to FIG. 3, an example flow 300 is illustrated showing various actions that may occur over a portion of the lifetime of some data at an example guest physical memory address (GPA) 0x1000. As illustrated at 302, a SLAT entry for GPA 0x1000 is invalid, meaning that there is no SLAT entry for that particular GPA. As illustrated at 304 a virtual machine attempts to perform a read at GPA 0x1000 causing a VM read intercept. As illustrated at 306, a hypervisor forwards the intercept to the virtualization stack 114 on the host. At 308, the virtualization stack 114 performs a virtualization lookup for a host virtual memory address (VA) corresponding to the GPA 0x1000. The look up yields VA 0x8301000. At 310, a virtual fault is generated for a read access on VA 0x8301000. The virtual fault handing from the memory manager 118 returns a system physical address (SPA) of 0x88000 defining an address in system memory where the data at GPA 0x1000 is physically located. Therefore, as illustrated at 314, the SLAT is updated to correlate GPA 0x1000 with SPA 0x88000 and to mark the data access as “Read Only.” At 316, the virtualization stack 114 completes read intercept handling and the hypervisor resumes guest virtual machine execution.

As illustrated at 318, time passes. At 320, the virtual machine attempts write access at GPA 0x1000. At 322, the hypervisor forwards the write access to the virtualization stack 114 on the host. At 324, the virtualization stack 114 performs a virtualization lookup for a host VA for GPA 0x1000. As noted previously, this is at VA 0x8301000. At 326 a virtual fault occurs for write access on VA 0x8301000. At 328, the virtual fault returns SPA 0X88000 in the physical memory. At 330, the SLAT entry for GPA 0x1000 is updated to indicate that the data access is “Read/Write.” At 332, the virtualization stack 114 completes write intercept handling. The hypervisor resumes guest virtual machine execution.

As illustrated at 334, some time passes. At 336, the host memory manager 118 runs a page combine pass to combine any pages in host physical memory that are functionally identical. At 338, the host memory manager 118 finds combine candidates for VA 0x8301000 and another virtual address in another process. At 340, the host performs a TLB flush for VA 0x8301000. At 342, the virtualization stack 114 intercepts the TLB flush. At 344, the SLAT entry for GPA 0x1000 is invalid. At 346, a virtual machine intercept is performed for GPA 0x1000. At 348, a virtual fault for read access on VA 0x8301000 occurs. At 350, the virtual fault return SPA 0x52000, which is the shared page between N processes from the page combine pass at 336. At 352, the SLAT entry for GPA 0x1000 is updated to correlate with SPA 0x52000, with access set to “Read Only.”

As illustrated at 354, some time passes. At 356, a virtual machine write intercept occurs for GPA 0x1000. At 358 a virtual fault for write access on VA 0x8301000 occurs. At 360, the host memory manager 118 performs a copy-on write on VA 0x8301000. At 362, the host performs a TLB flush for VA 0x830100. As illustrated at 364, this causes the SLAT entry for GPA 0X1000 to be invalidated. At 366, a virtual fault returns SPA 0x11000, which is a private page after the copy-on write. At 368, the SLAT entry for GPA 0x1000 is updated to SPA 0x1000 with access set to “Read/Write.” At 370 the virtualization stack 114 completes read intercept handling and the hypervisor resumes virtual machine execution.

Thus, as illustrated above, virtual machine physical address space is backed by host virtual memory (typically allocated in a host process' user address space), which is subject to regular virtual memory management by the host memory manager 118. Virtual memory backing the virtual machine's physical memory can be of any type supported by the host memory manager 118 (private allocation, file mapping, pagefile-backed section mappings, large page allocation, etc.) A host memory manager 118 can perform its existing operations and apply policies on the virtual memory and/or apply specialized policies knowing that the virtual memory is backing virtual machine's physical address space as necessary.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

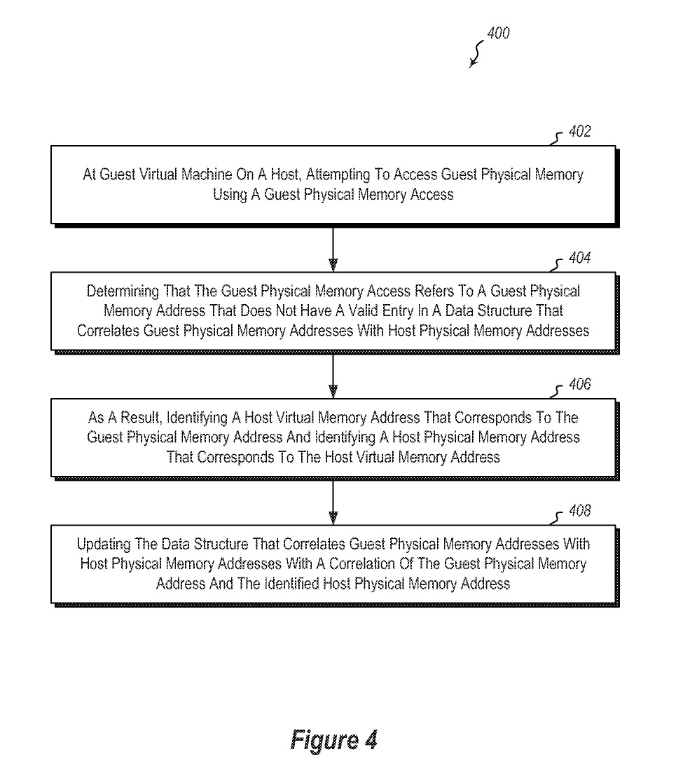

Referring now to FIG. 4, a method 400 is illustrated. The method 400 may be practiced in a virtual computing environment. The method includes acts for backing guest physical memory with host virtual memory. The method includes, at guest virtual machine on a host, attempting to access guest physical memory using a guest physical memory access (act 402). For example, the guest virtual machine 110-1 may access the guest physical memory 112-1.

The method 400 further includes determining that the guest physical memory access refers to a guest physical memory address that does not have a valid entry in a data structure that correlates guest physical memory addresses with host physical memory addresses (act 404). For example, a determination may be made that there is no valid entry in the SLAT 124-1.

As a result, the method 400 includes identifying a host virtual memory address that corresponds to the guest physical memory address and identifying a host physical memory address that corresponds to the host virtual memory address (act 406). For example, the virtualization stack 114 can identify a host virtual memory address that corresponds to the guest physical memory address and the memory manager 118 can identify a host physical memory address that corresponds to the host virtual memory address.

The method 400 further includes updating the data structure that correlates guest physical memory addresses with host physical memory addresses with a correlation of the guest physical memory address and the identified host physical memory address (act 408). For example, the virtualization stack 114 can obtain the host physical memory address from the memory manager 118 update SLAT 124-1 with a correlation of the guest physical memory address and the identified host physical memory address.

The method 400 may be practiced by causing an intercept. The intercept is forwarded to a virtualization stack 114 on the host. This causes the virtualization stack 114 to identify the host virtual memory address that corresponds to the guest physical memory address and to issue a fault to a memory manager 118 to obtain the host physical memory address that corresponds to the host virtual memory address. The virtualization stack 114 updates the data structure that correlates guest physical memory addresses with host physical memory addresses with a correlation of the guest physical memory address and the identified host physical memory address.

The method 400 may further include determining a type for the guest physical memory access and updating the data structure that correlates guest physical memory addresses with host physical memory addresses with the determined type correlated to the guest physical memory address and the identified host physical memory address. For example, if the guest physical memory access is a read, the SLAT 124-1 could be updated to so indicate.

The method 400 may further include performing an action that may change a host physical memory address backing the host virtual memory address. As a result, the method may include invalidating an entry correlating the guest physical memory address with the host physical memory address in the data structure that correlates guest physical memory addresses with host physical memory addresses. This causes subsequent access to the guest physical memory address to generate a fault which can be used to update the data structure that correlates guest physical memory addresses with host physical memory addresses with a correct correlation for host virtual memory backing the guest physical memory address. For example, the action may include a page combining operation. Page combining may be used to increase the density of virtual machines on a host.

The method 400 may include initializing the guest virtual machine. As part of initializing guest virtual machine, the method 400 may include prepopulating at least a portion of the data structure that correlates guest physical memory addresses with host physical memory addresses with some or all guest physical memory address to host physical memory address mappings for the guest virtual machine. Thus, for example, host physical memory could be pre-allocated for a virtual machine and appropriate correlations entered into the SLAT. This would result in fewer exceptions being needed to initialize the guest virtual machine.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures 126. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a virtual computing environment, a system for backing guest physical memory with host virtual memory, the system comprising:
a guest virtual machine on a host machine, wherein the guest virtual machine is configured to access guest physical memory;
a second level address translation table (SLAT) that correlates guest physical memory addresses with host physical memory addresses;
a virtualization stack configured to correlate guest physical memory addresses with host virtual memory addresses;
a memory manager configured to correlate host virtual memory addresses with host physical memory addresses;
a hypervisor configured to receive an intercept when a guest virtual machine guest physical memory access refers to a guest physical memory address that does not have a valid entry in the SLAT and to forward the intercept to the virtualization stack; and
wherein the virtualization stack is configured to:
identify a host virtual machine memory address corresponding to a guest physical machine memory address from the guest virtual machine guest physical memory access;
obtain from the memory manager a host physical machine memory address corresponding to the host virtual memory address; and
update the SLAT with a correlation of the guest physical memory address and the host physical memory address.

2. The system of claim 1, further comprising one or more host processes where host virtual memory is implemented.

3. A host machine, wherein the host machine comprises:
host physical memory;
one or more guest virtual machines, wherein each of the guest virtual machines comprises guest physical memory;
host virtual memory;
a data structure having a correlation of guest physical memory addresses to host virtual memory addresses; and
a data structure having a correlation of host virtual memory addresses to host physical memory addresses.

4. The host machine of claim 3, wherein the virtual memory is included as part of a user process being run on the host machine.

5. The host machine of claim 4, wherein the host machine is configured to back guest physical memory of the guest virtual machines by allocating virtual memory in user processes for use by guest physical memory with a different user processes being used for each guest virtual machine.

6. The host machine of claim 4, wherein the host machine is configured to back guest physical memory of the guest virtual machines by allocating virtual memory in one or more user processes for use by guest physical memory with a user process being used for a plurality of guest virtual machines.

7. The host machine of claim 3, wherein the virtual memory is included as part of a kernel virtual address space.

8. The host machine of claim 3, further comprising a virtualization stack that is configured to allocate host virtual memory to guest physical memory.

9. The host machine of claim 8, wherein the virtualization stack comprises the data structure having the correlation of guest physical memory addresses to host virtual memory addresses.

10. The host machine of claim 8, wherein the host machine further comprises one or more second level address tables (SLATs) that correlate guest physical memory addresses with host physical memory addresses and wherein the virtualization stack is configured to intercept translation buffer flushes and based on the intercepted translation buffer flushes, identify entries in the SLATs to be invalidated.

11. The host machine of claim 8, wherein the host machine further comprises one or more second level address tables (SLATs) that correlate guest physical memory addresses with host physical memory addresses and a hypervisor and wherein hypervisor is configured to receive guest access intercepts when a SLAT does not contain a valid entry for a guest physical memory access and to forward the guest access intercepts to the virtualization stack; and wherein the virtualization stack is configured to identify host virtual memory corresponding to the guest physical memory accesses such that the SLATs can be updated to correlate addresses for the guest physical memory accesses with a host physical memory addresses.

12. The host machine of claim 3, further comprising a memory manager, and wherein the memory manager stores the data structure having a correlation of host virtual memory addresses to host physical memory addresses.

13. The host machine of claim 3, further comprising a memory manager, and wherein the memory manager is configured to manage guest physical memory by managing host virtual memory.

14. The host machine of claim 13, further comprising a hypervisor, and wherein the hypervisor is configured to offload management of guest physical memory to the memory manager.

15. In a virtual computing environment, a method of backing guest physical memory with host virtual memory, the method comprising:
at guest virtual machine on a host, attempting to access guest physical memory using a guest physical memory access;
determining that the guest physical memory access refers to a guest physical memory address that does not have a valid entry in a data structure that correlates guest physical memory addresses with host physical memory addresses;
as a result, identifying a host virtual memory address that corresponds to the guest physical memory address and identifying a host physical memory address that corresponds to the host virtual memory address; and
updating the data structure that correlates guest physical memory addresses with host physical memory addresses with a correlation of the guest physical memory address and the identified host physical memory address.

16. The method of claim 15, wherein determining that the guest physical memory access refers to a guest physical memory address that does not have a valid entry in a data structure that correlates guest physical memory addresses with host physical memory addresses causes an intercept that is forwarded to a virtualization stack on the host which causes the virtualization stack to identify the host virtual memory address that corresponds to the guest physical memory address and to issue a fault to a memory manager to obtain the host physical memory address that corresponds to the host virtual memory address, and to update the data structure that correlates guest physical memory addresses with host physical memory addresses with a correlation of the guest physical memory address and the identified host physical memory address.

17. The method of claim 15, further comprising determining a type for the guest physical memory access and updating the data structure that correlates guest physical memory addresses with host physical memory addresses with the determined type correlated to the guest physical memory address and the identified host physical memory address.

18. The method of claim 15, further comprising performing an action that may change a host physical memory address backing the host virtual memory address, and as a result, invalidating an entry correlating the guest physical memory address with the host physical memory address in the data structure that correlates guest physical memory addresses with host physical memory addresses which causes subsequent access to the guest physical memory address to generate a fault which can be used to update the data structure that correlates guest physical memory addresses with host physical memory addresses with a correct correlation for host virtual memory backing the guest physical memory address.

19. The method of claim 18, wherein the action comprises a page combining operation.

20. The method of claim 15 further comprising, initializing the guest virtual machine, and as part of initializing guest virtual machine, prepopulating at least a portion of the data structure that correlates guest physical memory addresses with host physical memory addresses with some or all guest physical memory address to host physical memory address mappings for the guest virtual machine.
